(19) United States
(12) Patent Application Publication
(10) Pub. No.: US 2026/0216543 A1
(43) Pub. Date: Jul. 30, 2026

(54) REMOVABLE SPRINKLER PROTECTION DEVICE

(71) Applicant: Tyco Fire Products LP, Cranston, RI (US)

(72) Inventors: Vivekanandan S, Chennai (IN); Bharani Kannan, Chennai (IN)

(73) Assignee: Tyco Fire Products LP, Cranston, RI (US)

(21) Appl. No.: 19/144,066

(22) PCT Filed: Jan. 9, 2024
(86) PCT No.: PCT/IB2024/050224

§ 371 Date: Jun. 27, 2025

Related U.S. Application Data
(60) Provisional application No. 63/483,832, filed on Feb. 8, 2023.

(51) Int. Cl. A62C 31/02; A62C 31/28; A62C 37/11; B05B 15/16

(52) U.S. Cl. CPC A62C 31/02; A62C 31/28; A62C 37/11; B05B 15/16

(57) ABSTRACT

At least one aspect is directed to a sprinkler protection device. The sprinkler protection device can include a first surface extending from a first end to a second end. The sprinkler protection device can include at least one edge extending along the first surface between the first end and the second end. The sprinkler protection device can include a plurality of ribs extending in a first direction outward from the first surface, at least one rib of the plurality of ribs proximate the at least one edge.

### CROSS-REFERENCE TO RELATED APPLICATIONS

The present application claims the benefit of and priority to U.S. Provisional Application No. 63/483,832, filed Feb. 8, 2023, the disclosure of which is incorporated herein by reference in its entirety.

### BACKGROUND

Buildings and other areas can include sprinklers to provide fire protection. In the event of a fire, the sprinklers can dispense a fluid to control, suppress or extinguish the fire that occurs beneath an exterior projection.

### SUMMARY

At least one aspect relates to a sprinkler protection device. The sprinkler protection device can include a first surface extending from a first end to a second end. The sprinkler protection device can include at least one edge extending along the first surface between the first end and the second end. The sprinkler protection device can include a plurality of ribs extending in a first direction outward from the first surface. At least one rib of the plurality of ribs can be proximate the at least one edge.

At least one aspect relates to a sprinkler assembly. The sprinkler assembly can include a sprinkler and a sprinkler protection device. The sprinkler can include a thermal trigger extending between a deflector and a seal. The sprinkler protection device can include at least one edge extending along the first surface between the first end and the second end.

The sprinkler protection device can include a plurality of ribs extending in a first direction outward from the first surface. At least one rib of the plurality of ribs can be proximate the at least one edge.

### BRIEF DESCRIPTION OF THE DRAWINGS

FIG. 1 is a front view of an example of a sprinkler assembly.

FIG. 2 is a perspective view of an example of a sprinkler protection device.

FIG. 3 is a rear view of an example of a sprinkler protection device.

### DETAILED DESCRIPTION

Following below are more detailed descriptions of various concepts related to, and implementations of, methods, apparatuses, and systems of a sprinkler protection device. The various concepts introduced above and discussed in greater detail below may be implemented in any of numerous ways.

The present disclosure generally refers to a sprinkler protection device (e.g., protector) that can prevent damage to a fire protection sprinkler (e.g., fluid distribution device) with transportation of or installment of the sprinkler. Sprinklers can have various components, such as thermal triggers that include glass bulbs or soldered link and lever assemblies, that can be susceptible to damage during transportation/shipment or installation. Protectors can be made of plastic or other polymeric materials and can be positioned around these components to reduce the likelihood of damage; however, such devices may be difficult to dispose of through waste management and/or recycling processes after use. For example, some protectors may be made of thermoplastics such as high-density polyethylene, which can have degradation times on the order of tens or hundreds of years.

Systems and methods in accordance with the present disclosure can use protectors made of materials that achieve targets for both performance characteristics, such as strength, rigidity, resilience, and/or weight/density, and degradation characteristics, such as expected time for degrading into various sub-materials that may capable of being metabolized or otherwise further broken down by micro-organisms or other natural processes. For example, protectors can be made from a biodegradable plastic, such as polyhydroxyalkanoates, such as polyhydroxybutyrate (PHB). The protectors can have structural features or components that enable the protectors to meet performance targets due to structural and/or manufacturing features. For example, the protectors can include one or more of a rib to be arranged about a longitudinal axis of the sprinkler; a ridge connecting a boss to a lock member that is to be arranged adjacent to the thermal trigger of the sprinkler; and sizing of the lock members.

For example, a protector can be made as a unitary body made of PHB, and can include a first surface extending from a first end to a second end. The sprinkler protection device can include at least one edge extending along the first surface between the first end and the second end. The sprinkler protection device can include a plurality of ribs extending in a first direction outward from the first surface. At least one rib of the plurality of ribs can be proximate the at least one edge, such as to define an opening for receiving a seal of a sprinkler between at least a first pair of the plurality of ribs. The sprinkler protection device can include lock members contiguous with fastener members on a second surface opposite the first surface, which can be formed adjacent to sprinkler receivers for receiving the sprinkler.

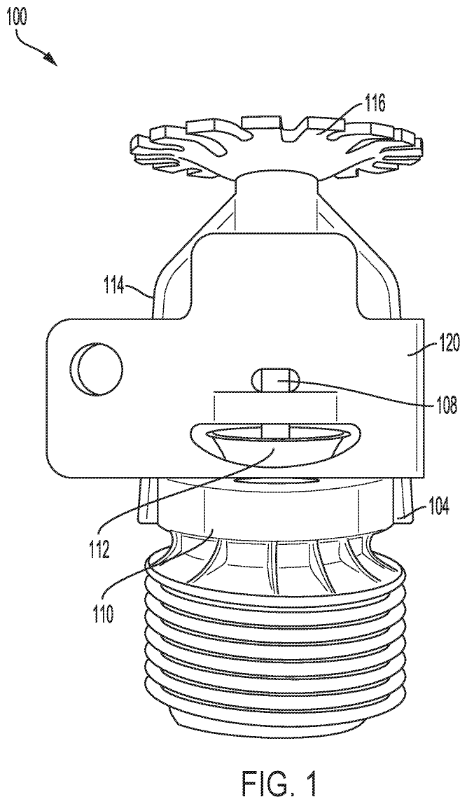

FIG. 1 depicts an example of a sprinkler assembly 100. The sprinkler assembly 100 can include a sprinkler 104 and a sprinkler protection device (e.g., protector) 120. The sprinkler assembly 100 can be used during various operations, including but not limited to packaging, shipping, and installation of the sprinkler 104. For example, prior to packaging of the sprinkler assembly 100, the protector 120 can be coupled with the sprinkler 104.

The sprinkler 104 can include a thermal trigger 108 (e.g., adjacent to a body 110 having an inlet and an outlet in which seal 112 can be coupled, and around which a frame 114 can extend). The thermal trigger 108 can include one or more structures that may be susceptible to damage during packaging, shipping, and installation of the sprinkler 104. For example, the thermal trigger 108 can include a glass bulb, or a soldered link and lever assembly; various such structures may be changed in shape or broken due to inadvertent contact with other structures in and around the sprinkler 104.

The protector 120 can at least partially cover the thermal trigger 108 and other portions of the sprinkler 104 to reduce or prevent the likelihood of contact with these structures. For example, as depicted in FIG. 1, the protector 120 can form one or more surfaces that face and/or are outward from the thermal trigger 108. The protector 120 can include one or more openings proximate to the thermal trigger 108 (e.g., to allow for visual inspection of the thermal trigger 108) and a seal 112 (e.g., sprinkler button) of the sprinkler 104. The protector 120 can be sized to extend less than a full length of the sprinkler 104; for example, the protector 120 may cover the thermal trigger 108 while leaving a deflector 116 and other portions of the sprinkler 104. The protector 120 can be sized to cover greater or lesser portions of the sprinkler 104.

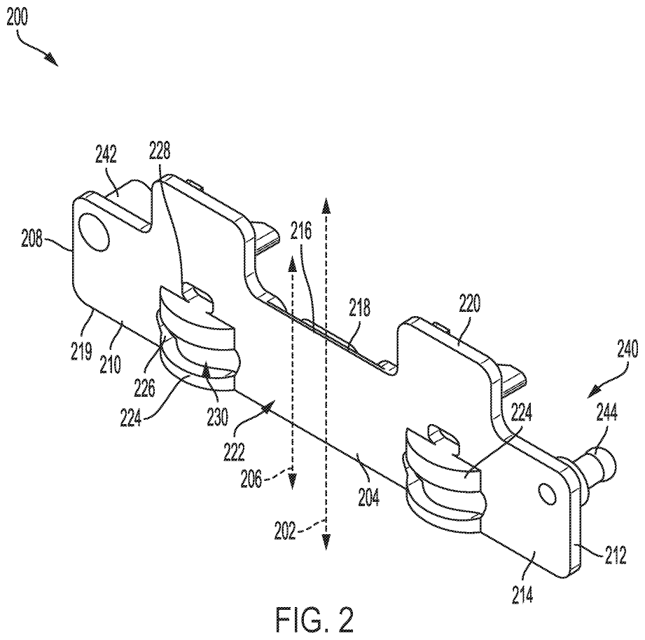

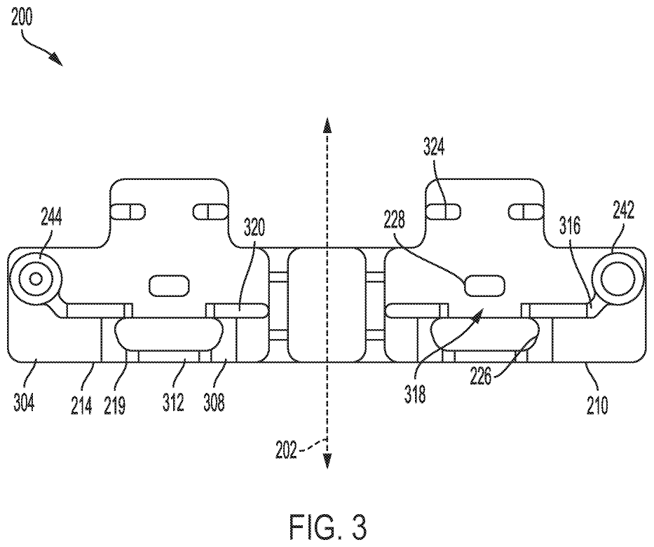

FIGS. 2 and 3 depict an example of a protector 200. The protector 200 can incorporate features of the protector 120 described with reference to FIG. 1, and can be used to protect components of the sprinkler 104 described with reference to FIG. 1. The protector 200 can have a body 204 that extends between a first end 208 and a second end 212 about an axis 202. The protector 200 can be at least partially symmetrical about the axis 202, such as to enable components of the protector 200 to be arranged around the sprinkler 104, such as to form a perimeter around a circumference of the sprinkler 104. For example, in a state of being secured around the sprinkler 104, the protector 200 can form a complete perimeter around the sprinkler 104 in a plurality of planes perpendicular to a longitudinal axis of the sprinkler 104.

The protector 200 can be made of a plastic and/or polymeric material. For example, protectors can be made from a biodegradable plastic, such as polyhydroxyalkanoates, such as polyhydroxybutyrate (PHB). For example, the polymeric material can be indicated as biodegradable by complying with one or more standards such as ASTM D6400, EN 13432, AS 4736, ISO 17088 standards test specifications. By making the protector 200 from a biodegradable material, the protector 200 can be more easily degraded after use, enabling a more sustainable lifecycle for the protector 200.

The protector 200 can be foldable about one or more fold axes 206. The fold axes 206 can form hinges of the protectors 200. For example, the portions of the body 204 along the fold axes 206 can be made of material that is at least one of less dense, more resilient (e.g., more flexible), or less thick than adjacent portions of the body 204. By making the protector 200 foldable, the protector 200 can be adjusted from the structure depicted in FIG. 2 to an arrangement analogous to that depicted for protector 120 of FIG. 1. For example, the protector 200 can be folded to form a first portion 210 proximate the first end 208, a second portion 214 proximate the second end 212, and a third, central portion 216 between the first portion 210 and the second portion 214. The first portion 210 and second portion 214 can each be longer than the third portion 216, such that the folded protector 200 defines a rectangular prism shape.

The protector 200 can include at least one extension 220 extending away from an edge 218 along the third portion 216. The extension 220 can be sized to be positioned in front of the thermal trigger 108 of the sprinkler 104 (e.g., in front of additional portions than the first portion 210 and second portion 214, such as portions proximate deflector 116).

As depicted in FIG. 2, the protector 200 can include a first surface 222 extending along the first portion 210, the second portion 214, and the third portion 216. A majority of the first surface 222 can be planar (e.g., flat) and free of openings. The first surface 222 can be curved or have curved portions. The first surface 222 can be an outer surface of the protector 200 relative to the sprinkler 104.

The protector 200 can include a plurality of ribs 224. The ribs 224 can be curved members extending from the first surface 222. For example, the ribs 224 can extend in a first direction outward from a plane in which the axes 202, 206 lie. As depicted in FIG. 2, the ribs 224 can extend in a direction transverse (e.g., perpendicular) to the axis 202.

The ribs 224 can include at least two ribs 224 centered along the first portion 210, and at least two ribs 224 centered along the second portion 214, such that the ribs 224 can be aligned with the sprinkler 104 and/or can at least partially receive the sprinkler 104 or components thereof. The ribs 224 on each side of the axis 202 (e.g., two ribs 224 of the first portion 210 and two ribs 224 of the second portion 214, respectively) can have similar or identical curvatures as they extend outward from the first surface 222.

The ribs 224 can include at least one rib 224 proximate (e.g., at or adjacent to) an edge 219 opposite the edge 218. For example, the at least one rib 224 can be within a threshold distance (e.g., less than 1 centimeter; less than 1 millimeter; less than twenty percent of the distance between the edges 218, 219) from the edge 219 or can be at no distance from the edge 219 (e.g., the rib 224 can form a portion of the edge 219); the at least one rib 224 can be in contact with the edge 219; the at least one rib 224 can at least partially extend in a plane extending from the edge 219. The ribs 224 proximate the edges 219 can be used to provide greater strength of the protector 200 (e.g., without increasing or significantly increasing the size of the protector 200, such as by forming a gap between the side of the ribs 224 to face towards the sprinkler 104 and a central plane through the body 204) about the sprinkler 104, including in proximity to components of the sprinkler 104 such as the seal 112. This can facilitate enabling the protector 200 to use biodegradable material while meeting performance targets.

The body 204 can define at least one first opening 226 between the ribs 224 of at least one of the first portion 210 or the second portion 214. The first openings 226 can be sized and positioned to provide space for the protector 200 to receive components of the sprinkler 104, and can allow for visual inspection of one or more components of the sprinkler 104. As depicted in FIGS. 2 and 3, the first openings 226 can extend at least partially between the edges 218, 219, such as to extend from the ribs 224 to a point less than halfway between the edges 218, 219. This can allow for sufficient coverage of the sprinkler 104 while providing space for visual inspection.

The body 204 can define at least one second opening 228 between the ribs 224 and the extensions 220. The second openings 228 can be sized and positioned to provide a space for inspection of the sprinkler 104 (e.g., of thermal trigger 108). The second openings 228 can have a lesser width (e.g., in a direction transverse to the axis 202) than the first openings 226. As depicted in FIGS. 2 and 3, the ribs 224 adjacent the second openings 228 can have material extending across a central plane of the body 204 (e.g., to second, inner surface 304), as compared with the ribs 224 proximate the edge 219, which may at least partially define a space 230 between the central plane and an inner edge of the ribs 224 proximate the edge 219 (e.g., no material may be present between the ribs 224 and the central plane and/or second surface 304).

The protector 200 can include at least one fastener assembly 240. The fastener assembly 240 can be used to couple the first portion 210 with the second portion 214 (e.g., responsive to folding of the protector 200 about fold axes 206). The fastener assembly 240 can be positioned relative to the first end 208 and second end 212 such that in a fastened state of the protector 200, the ribs 224 are substantially equidistant from the axis 202, enabling the sprinkler 104 to be received between the ribs 224.

The fastener assembly 240 can include a first member 242 and a second member 244. The first member 242 can be a receiver, and the second member 244 can be received by the first member 242; for example, the second member 244 can be a boss to be received by the first member 242. The second member 244 can be received by the first member 242 responsive to manipulation (e.g., folding) of the protector 200 about the fold axes 206. As depicted in FIGS. 2 and 3, the first member 242 can be proximate (e.g., at or adjacent to) the first end 208 and the edge 218, and the second member 244 can be proximate the second end 212 and the edge 218. The fastener members 242, 244 can extend away from the first surface 222 and/or second surface 304 in a direction opposite the ribs 224.

Referring further to FIG. 2 and to FIG. 3, the protector 200 can include a second, inner surface 304 opposite the first, outer surface 222. The first fastener member 242 and the second fastener member 244 can extend from the second surface 304. The protector 200 can include at least one sprinkler receiver 308 to receive the sprinkler 104. For example, the sprinkler receivers 308 can extend from the second surface 304 towards the first surface 222, such as to define an arcuate space for receiving and coupling with the sprinkler 104. The sprinkler receivers 308 can be defined by inner edges 312 of the ribs 224 that are proximate the edge 219.

The protector 200 can include a plurality of lock members 316, 320. The lock members 316, 320 can be arranged to engage the sprinkler 104. The lock members can include outer lock members 316 proximate the ends 208, 212 of the protector 200 relative to inner lock members 320 proximate the axis 202. The lock members 316, 320 can be elongated members that extend (e.g., protrude) from the second surface 304 in an opposite direction from that by which the ribs 224 extend from the first surface 222. The lock members 316, 320 can be adjacent to the openings 226. At least a portion of the lock members 316, 320 can extend transverse to the axis 202, such as to extend parallel with the edge 219. The lock members 320 can be proximate the fold axes 206. A gap 318 can be formed between the lock members 316, 320 opposite where the ribs 224 are formed to extend from the first surface 222.

As depicted in FIG. 3, the outer lock members 316 can extend to the fastener members 242, 244 to be contiguous with the fastener members 242, 244 (e.g., as compared to the protruding aspects of the lock members 316 terminating away from the fastener members 242, 244 to define gaps between the lock members 316 and respective fastener members 242, 244). For example, the lock members 316 can be outward, such as to protrude outward, from the second surface 304 from the openings 226 to the fastener members 242, 244.

The lock members 316 and fastener members 242, 244 can be made as monolithic or integral members. As depicted in FIG. 3, the lock members 316 can extend transverse to the axis 202 away from the axis 202 for at least a portion, and upwards to the fastener members 242, 244 to connect with the fastener members 242, 244. By making the lock members 316 contiguous with the fastener members 242, 244, the lock members 316 can provide greater rigidity and/or otherwise more effectively limit or distribute forces on the sprinkler 104 received between the lock members 316, 320.

Referring further to FIG. 3, the protector 200 can include lock members 324 extending from the extensions 220 away from the second surface 304. The lock members 324 can be sized and positioned to receive components of the sprinkler 104 such as a compression screw at an opposite end of the thermal trigger 108 from the seal 112. The lock members 324 can extend parallel with at least the inner portions of the lock members 316, 320 out to lateral edges of the extensions 220. The lock members 320, 324 can be symmetrical about the axis 202.

At least some of the lock members 316, 320, 324 can be sized to facilitate protection of the sprinkler 104 while meeting weight or other performance targets for the protector 200. For example, the lock members 316, 320, 324 can have thicknesses (e.g., heights in the direction parallel with the axis 202) that are substantially equal. The lock members 324 can be spaced apart from each other less than the lock members 316, 320.

The thicknesses can be between one twentieth and one fourth the height of the protector 200 (e.g., as measured to include the extensions 220). The thicknesses can be less than a height of the first openings 226. The thicknesses can be less than a height of the second openings 228. The thicknesses can be less than 1.5 times the height of the first openings 226. The thicknesses can be less than 1.5 times the height of the second openings 228. Various such sizings of the lock members 316, 320, 324 can enable biodegradable material to be used to manufacture the protector 200 while meeting performance targets. References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure. References herein to the order of elements (e.g., “first,” “second,” “third,” “fourth,” “fifth,” “sixth,” “seventh”) are merely used for ease of description relative to each element in the FIGURES.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Systems and methods described herein may be embodied in other specific forms without departing from the characteristics thereof. For example, the removable sprinkler protection device 100 may be used in various sprinkler applications. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A sprinkler assembly, comprising:
a sprinkler, comprising a thermal trigger extending between a deflector and a seal; and
a protector coupled with the sprinkler, the protector made of a biodegradable material, the protector comprising:
a first surface extending from a first end to a second end;
at least one edge extending along the first surface between the first end and the second end; and
a plurality of ribs extending in a first direction outward from the first surface, at least one rib of the plurality of ribs within a threshold distance from the at least one edge, the threshold distance less than one centimeter from the at least one edge.

2. The sprinkler assembly of claim 1, comprising:
the protector comprises:
a second surface opposite the first surface; and
at least one fastener member extending outward from the second surface in a second direction opposite the first direction.

3. The sprinkler assembly of claim 1, comprising:
the protector comprises:
a second surface opposite the first surface; and
at least one sprinkler receiver defined by the at least one rib and the second surface.

4. The sprinkler assembly of claim 1, comprising:
the protector comprises:
a second surface opposite the first surface; and
a plurality of lock members extending in a second direction opposite the first direction from the second surface.

5. The sprinkler assembly of claim 1, comprising:
the biodegradable material comprises a polyhydroxyalkanoate.

6. The sprinkler assembly of claim 1, comprising:
the biodegradable material comprises polyhydroxybutyrate.

7. The sprinkler assembly of claim 1, comprising:
the protector comprises:
an axis between the first end and the second end;
a first portion on a first side of the axis, the plurality of ribs comprising a first pair of ribs extending from the first portion, the first portion defining a first opening between the first pair of ribs and a second opening; and
a second portion on a second side of the axis, the plurality of ribs comprising a second pair of ribs extending from the second portion, the second portion defining a third opening between the second pair of ribs and a fourth opening.

8. The sprinkler assembly of claim 1, comprising:
the protector comprises:
an axis between the first end and the second end;
a first portion on a first side of the axis, the plurality of ribs comprising a first pair of ribs extending from the first portion, the first portion defining a first opening between the first pair of ribs and a second opening;
a second portion on a second side of the axis, the plurality of ribs comprising a second pair of ribs extending from the second portion, the second portion defining a third opening between the second pair of ribs and a fourth opening; and
a plurality of lock members extending from a second surface opposite the first surface, the plurality of lock members having a height less than a height of each of the first opening, the second opening, the third opening, and the fourth opening.

9. The sprinkler assembly of claim 1, comprising:
the protector comprises a foldable member.

10. The sprinkler assembly of claim 1, comprising:
at least one extension extending from the at least one edge.

11. A biodegradable sprinkler protection device, comprising:
a first surface extending from a first end to a second end;
at least one edge extending along the first surface between the first end and the second end; and
a plurality of ribs extending in a first direction outward from the first surface, at least one rib of the plurality of ribs adjacent to the at least one edge.

12. The biodegradable sprinkler protection device of claim 11, comprising:
a second surface opposite the first surface; and
at least one fastener member extending outward from the second surface in a second direction opposite the first direction.

13. The biodegradable sprinkler protection device of claim 11, comprising:
a second surface opposite the first surface; and
at least one sprinkler receiver defined by the at least one rib and the second surface.

14. The biodegradable sprinkler protection device of claim 11, comprising:
a second surface opposite the first surface; and
a plurality of lock members extending in a second direction opposite the first direction from the second surface.

15. The biodegradable sprinkler protection device of claim 11, comprising:
the biodegradable sprinkler protection device comprises a polyhydroxyalkanoate.

16. The biodegradable sprinkler protection device of claim 11, comprising:
the biodegradable sprinkler protection device comprises polyhydroxybutyrate.

17. The biodegradable sprinkler protection device of claim 11, comprising:
a first portion on a first side of an axis between the first end and the second end, the plurality of ribs comprising a first pair of ribs extending from the first portion, the first portion defining a first opening between the first pair of ribs and a second opening; and
a second portion on a second side of the axis, the plurality of ribs comprising a second pair of ribs extending from the second portion, the second portion defining a third opening between the second pair of ribs and a fourth opening.

18. The biodegradable sprinkler protection device of claim 11, comprising:
a first portion on a first side of an axis between the first end and the second end, the plurality of ribs comprising a first pair of ribs extending from the first portion, the first portion defining a first opening between the first pair of ribs and a second opening;
a second portion on a second side of the axis, the plurality of ribs comprising a second pair of ribs extending from the second portion, the second portion defining a third opening between the second pair of ribs and a fourth opening; and
a plurality of lock members extending from a second surface opposite the first surface, the plurality of lock members having a height less than a height of each of the first opening, the second opening, the third opening, and the fourth opening.

19. The biodegradable sprinkler protection device of claim 11, comprising:
the biodegradable sprinkler protection device comprises a foldable member.

20. The biodegradable sprinkler protection device of claim 11, comprising:
at least one extension extending from the at least one edge.
